(19) United States
(12) Patent Application Publication
(10) Pub. No.: US 2026/0319888 A1
(43) Pub. Date: Oct. 15, 2026

(54) TERMINATING ERROR CORRECTION USING PARTIAL SYNDROME CALCULATIONS

(71) Applicant: Micron Technology, Inc., Boise, ID (US)

(72) Inventors: Eyal En Gad, Highland, CA (US); Mariano Eduardo Burich, San Diego, CA (US); Phong Sy Nguyen, Livermore, CA (US); Mustafa N. Kaynak, San Diego, CA (US); Sivagnanam Parthasarathy, Carlsbad, CA (US)

(21) Appl. No.: 19/174,117

(22) Filed: Apr. 9, 2025

(51) Int. Cl. G06F 11/10

(52) U.S. Cl. CPC G06F 11/1068; G06F 11/1048

(57) ABSTRACT

Methods, systems, and apparatuses include determining that codeword read from a memory device contains one or more errors. A parity check matrix is received. A partial syndrome is calculated using a parity portion of the parity check matrix and the codeword. An error correction termination counter is incremented in response to the partial syndrome indicating no errors in the codeword for the parity portion. The codeword is decoded in response to determining that the error correction termination counter satisfies a termination threshold.

### TECHNICAL FIELD

The present disclosure generally relates to error correction termination, and more specifically, relates to error correction termination using partial syndromes.

### BACKGROUND ART

A memory subsystem can include one or more memory devices that store data. The memory devices can be, for example, non-volatile memory devices and volatile memory devices. In general, a host system can utilize a memory subsystem to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory subsystem in accordance with some embodiments of the present disclosure.

FIG. 2 is a flow diagram of an example method to terminate error correction using partial syndromes in accordance with some embodiments of the present disclosure.

FIG. 3 is a flow diagram of an example method to terminate error correction using partial syndromes in accordance with some embodiments of the present disclosure.

FIG. 4 is another flow diagram of an example method to terminate error correction using partial syndromes in accordance with some embodiments of the present disclosure.

FIG. 5 is a block diagram of an example computer system in which embodiments of the present disclosure may operate.

### DETAILED DESCRIPTION

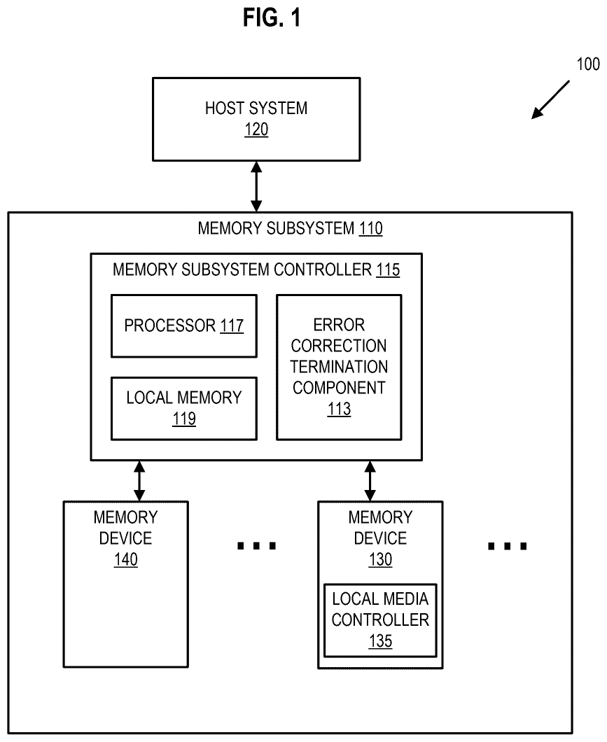

Aspects of the present disclosure are directed to error correction termination using partial syndrome calculations in a memory subsystem. A memory subsystem can be a storage device, a memory module, or a hybrid of a storage device and memory module. Examples of storage devices and memory modules are described below in conjunction with FIG. 1. In general, a host system can utilize a memory subsystem that includes one or more components, such as memory devices that store data. The host system can provide data to be stored on the memory subsystem and can request data to be retrieved from the memory subsystem.

A memory device can be a non-volatile memory device. A non-volatile memory device is a package of one or more dice. One example of non-volatile memory devices is a negative-and (NAND) memory device. Other examples of non-volatile memory devices are described below in conjunction with FIG. 1. The dice in the packages can be assigned to one or more channels for communicating with a memory subsystem controller. Each die can consist of one or more planes. Planes can be grouped into logic units identified by a logical unit number (LUN). For some types of non-volatile memory devices (e.g., NAND memory devices), each plane consists of a set of physical blocks, which are groups of memory cells to store data. A cell is an electronic circuit that stores information.

Depending on the cell type, a cell can store one or more bits of binary information, and has various logic states that correlate to the number of bits being stored. The logic states can be represented by binary values, such as “0” and “1”, or combinations of such values. There are various types of cells, such as single-level cells (SLCs), multi-level cells (MLCs), triple-level cells (TLCs), quad-level cells (QLCs), and penta-level cells (PLCs). For example, an SLC can store one bit of information and has two logic states while a QLC can store sixteen bits of information and has sixteen logic states.

In conventional memory systems, various internal and external factors can result in errors in data stored in memory devices. For example, data stored for long periods of time or stored in environments subject to environmental factors such as heat and humidity can result in errors in the data stored. Additionally, manufacturing and/or processing defects can result in stored user data that contains values that do not match the user data values at the time of programming. Additionally, as memory devices grow in storage size and include more and more dense cell types, these problems become more and more acute as the density of cell types is inversely proportional to the data reliability. Accordingly, conventional memory systems employ parity check measures such as low-density parity check code (LDPC) algorithms to ensure the reliability of stored user data and to correct errors present in said data.

These parity check algorithms use parity matrices to encode parity codes stored alongside the user data. When the user data is read from memory, these parity check algorithms are used to determine whether errors are present and, in some cases, correct those errors. One such algorithm is a min-sum algorithm (MSA) which calculates a syndrome using the parity matrix and the user data. While decoding the user data, such algorithms will update the syndrome as the user data is decoded (e.g., as bits are corrected) and will exit the error correction when a termination condition is met. For example, the termination condition can be the syndrome equaling a given value, the decoding time satisfying a threshold time limit, and/or decoding iterations satisfying an iteration limit. For large parity matrices, however, syndrome calculation can be complex. In particular, when using parity matrices with high weights, continually updating the syndrome can cause large increases in latency. For example, during decoding, matrices with high weights can require multiple clock cycles to update the syndrome. The weights of a parity matrix or portion of parity matrix refer to the number of parity-check equations that each codeword bit must satisfy (e.g., the number of non-zero elements of the parity matrix). For LDPC algorithms, this scenario occurs when using irregular matrices where portions of the matrix have low weights and other portions have high weights. Calculating and updating the entire syndrome when decoding the data using the dense portions of the matrix can be computationally intensive and take multiple clock cycles to calculate/update the entirety of the syndrome. Accordingly, calculating the syndrome for the higher weight portions of the parity matrix results in increases in latency.

Aspects of the present disclosure address the above and other deficiencies by determining when to terminate error correction using partial syndromes. For example, rather than tracking and updating the entire syndrome for the parity matrix during decoding of user data, the memory subsystem calculates partial syndromes for different portions of the parity matrix and increments an error correction termination counter for each partial syndrome until a termination condition is satisfied. By calculating partial syndromes, the memory subsystem can update the partial syndromes while decoding user data in fewer clock cycles than would be required for updating the full syndrome. Accordingly, the memory subsystem can reduce the latency of error correction when compared to previous methods.

FIG. 1 illustrates an example computing system 100 that includes a memory subsystem 110 in accordance with some embodiments of the present disclosure. The memory subsystem 110 can include media, such as one or more volatile memory devices (e.g., memory device 140), one or more non-volatile memory devices (e.g., memory device 130), or a combination of such.

A memory subsystem 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory subsystems 110. In some embodiments, the host system 120 is coupled to different types of memory subsystems 110. FIG. 1 illustrates one example of a host system 120 coupled to one memory subsystem 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processing device such as a processor chipset and a software stack executed by the processor chipset. The processor chipset can include one or more cores, one or more caches, a memory controller (e.g., NVDIMM controller), and/or a storage protocol controller (e.g., a peripheral component interconnect express (PCIe) controller, a serial advanced technology attachment (SATA) controller). The host system 120 uses the memory subsystem 110, for example, to write data to the memory subsystem 110 and read data from the memory subsystem 110.

The host system 120 can be coupled to the memory subsystem 110 via a physical host interface. Examples of a physical host interface include, but are not limited to, a SATA interface, including a mini-SATA (mSATA) interface, a PCIe interface, including a mini PCIe (mPCIE) interface, a Non-Volatile Memory Express (NVMe) interface, a universal serial bus (USB) interface, an a Fibre Channel, Serial Attached SCSI (SAS), a Small Computer System Interface (SCSI), a double data rate (DDR) memory bus, a dual in-line memory module (DIMM) interface (e.g., DIMM socket interface that supports Double Data Rate (DDR)), an Advanced Host Controller (AHCI) interface, an Open NAND Flash Interface (ONFI) interface, a Double Data Rate (DDR) interface, a Low Power Double Data Rate (LPDDR) interface, any other interface, and/or combinations of these interfaces. The physical host interface can be used to transmit data between the host system 120 and the memory subsystem 110. The host system 120 can further utilize an NVMe interface to access components (e.g., memory devices 130 and 140) when the memory subsystem 110 is coupled with the host system 120 by the PCIe interface. The physical host interface can provide an interface for passing control, address, data, and other signals between the memory subsystem 110 and the host system 120. FIG. 1 illustrates a memory subsystem 110 as an example. In general, the host system 120 can access multiple memory subsystems via the same communication connection, multiple separate communication connections, and/or a combination of communication connections.

The memory devices 130 and 140 can include any combination of the different types of non-volatile memory devices and/or volatile memory devices. The volatile memory devices (e.g., memory device 140) can be, but are not limited to, random-access memory (RAM), such as dynamic random-access memory (DRAM), synchronous dynamic random-access memory (SDRAM), video random-access memory (VRAM), and cache memory.

Some examples of non-volatile memory devices (e.g., memory device 130) include negative-and (NAND) type flash memory devices and write-in-place type memory devices, such as a three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write-in-place operation, where a non-volatile memory cell can be programmed without the non-volatile memory cell being previously erased. NAND type flash memory includes, for example, two-dimensional NAND (2D NAND) and three-dimensional NAND (3D NAND).

Although non-volatile memory devices such as NAND type memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random-access memory (FeRAM), magneto random-access memory (MRAM), Spin Transfer Torque (STT)-MRAM, nano-RAM (NRAM), silicon-oxide-nitride-oxide-silicon (SONOS) memory, conductive bridging RAM (CBRAM), resistive random-access memory (RRAM), oxide based RRAM (OxRAM), negative- or (NOR) flash memory, and erasable programmable read-only memory (EPROM), including electrically erasable programmable read-only memory (EEPROM).

A memory subsystem controller 115 (or controller 115 for simplicity) can communicate with the memory devices 130 to perform operations such as reading data, writing data, or erasing data at the memory devices 130 and other such operations (e.g., in response to commands scheduled on a command bus by controller 115). The memory subsystem controller 115 can include hardware such as one or more integrated circuits and/or discrete components, a buffer memory, or a combination thereof. The hardware can include digital circuitry with dedicated (i.e., hard-coded) logic to perform the operations described herein. The buffer memory of subsystem controller 115 can include any of the volatile or non-volatile memory types mentioned above including combinations thereof. The memory subsystem controller 115 can be a microcontroller, special purpose logic circuitry (e.g., a field programmable gate array (FPGA), an application specific integrated circuit (ASIC), etc.), or another suitable processor.

The memory subsystem controller 115 can include a processing device 117 (processor) configured to execute instructions stored in memory subsystem 110 (e.g., stored in a local memory 119). In some examples, the local memory 119 of the memory subsystem controller 115 includes an embedded memory configured to store instructions for performing various processes, operations, logic flows, and routines that control operation of the memory subsystem 110, including handling communications between the memory subsystem 110 and the host system 120.

In some embodiments, the local memory 119 can include memory registers storing memory pointers, fetched data, etc. The local memory 119 can also include read-only memory (ROM) for storing micro-code. While the example memory subsystem 110 in FIG. 1 has been illustrated as including the memory subsystem controller 115, in another embodiment of the present disclosure, a memory subsystem 110 does not include a memory subsystem controller 115, and can instead rely upon external control (e.g., provided by an external host, or by a processing device or controller separate from the memory subsystem 110).

In general, the memory subsystem controller 115 can receive commands or operations from the host system 120 and can convert the commands or operations into instructions or appropriate commands to achieve the desired access to the memory devices (e.g., memory devices 130 and/or 140. The memory subsystem controller 115 can be responsible for other operations such as wear leveling operations, garbage collection operations, error detection and error-correcting code (ECC) operations, encryption operations, caching operations, and address translations between a logical address (e.g., logical block address (LBA) and/or namespace) and a physical address (e.g., physical block address) that are associated with the memory devices (e.g., memory devices 130 and/or 140). The memory subsystem controller 115 can further include host interface circuitry to communicate with the host system 120 via the physical host interface. The host interface circuitry can convert the commands received from the host system into command instructions to access the memory devices (e.g., memory devices 130 and/or 140) as well as convert responses associated with the memory devices into information for the host system 120.

The memory subsystem 110 can also include additional circuitry or components that are not illustrated. In some embodiments, the memory subsystem 110 can include a cache or buffer (e.g., DRAM) and address circuitry (e.g., a row decoder and a column decoder) that can receive an address from the memory subsystem controller 115 and decode the address to access the memory devices (e.g., memory devices 130 and/or 140).

In some embodiments, the memory devices (e.g., memory devices 130 and/or 140) include local media controllers 135 that operate in conjunction with memory subsystem controller 115 to execute operations on one or more memory cells of the memory devices (e.g., memory devices 130 and/or 140). An external controller (e.g., memory subsystem controller 115) can externally manage the memory devices (e.g., perform media management operations on the memory devices 130 and/or 140). In some embodiments, a memory device (e.g., memory device 130) is a managed memory device, which is a raw memory device combined with a local controller (e.g., local controller 135) for media management within the same memory device package. An example of a managed memory device is a managed NAND (MNAND) device.

The memory subsystem 110 includes an error correction termination component 113 that determines when to end error correction using partial syndromes. In some embodiments, the controller 115 includes at least a portion of the error correction termination component 113. For example, the controller 115 can include a processing device 117 configured to execute instructions stored in local memory 119 for performing the operations described herein. In some embodiments, an error correction termination component 113 is part of the host system 120, an application, or an operating system.

The error correction termination component 113 calculates partial syndromes using user data and portions of a parity check matrix and determines when to terminate error correction using the partial syndrome. Further details with regards to the operations of the error correction termination component 113 are described below.

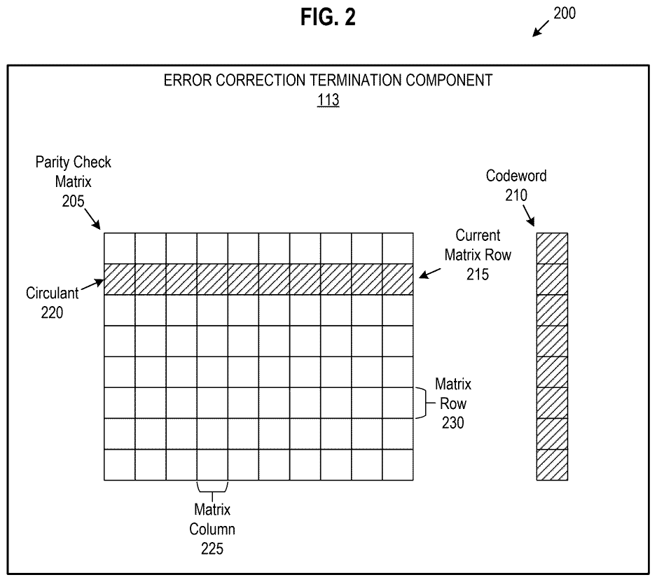

FIG. 2 illustrates another example computing system that includes an error correction termination component in accordance with some embodiments of the present disclosure. Error correction termination component 113 determines partial syndromes for correcting errors in codeword 210 using parity check matrix 205. Parity check matrix 205 is a matrix used for encoding and decoding user data. In some embodiments, parity check matrix 205 is an LDPC matrix. For example, parity check matrix 205 is a binary matrix with rows representing parity-check equations and columns representing bits of codeword 210. In such an example, each value of parity check matrix 205 therefore represents the relationship between the parity-check equations and the bits of codeword 210. For example, each row of parity check matrix 205 represents a parity check equation such that the result of a product operation for that row and codeword 210 should be zero if the codeword 210 contains no errors.

The codeword 210 includes the original data to be stored as well as parity information computed based on parity check matrix 205. Accordingly, when reading codeword 210 from storage, the memory subsystem can use parity check matrix 205 to decode codeword 210 by checking for errors in codeword 210 (e.g., due to memory degradation) and, in some cases, correcting the errors. For example, error correction termination component 113 can perform a product operation using each of matrix row 230 for parity check matrix 205 and codeword 210 to generate a partial syndrome that can identify whether there are errors present in codeword 210. In some embodiments, as described in further detail below, error correction termination component 113 performs these partial syndrome calculations using circulants. For example, as shown in FIG. 2, the code is a quasi cyclic code with each of matrix rows 230 including circulants such as circulant 220, which are subdivisions of their respective matrix rows. In such embodiments, error correction termination component 113 can calculate a partial syndrome for each row using the first circulant in that row and then update the partial syndrome for future circulants for that row. Further details regarding computing partial syndromes using circulants are described below.

In some embodiments, as shown in FIG. 2, parity check matrix 205 includes circulants such as circulant 220. For example, parity check matrix 205 includes a submatrix of circulants where each circulant is a permutation of other circulants. In such an example, because parity check matrix 205 is composed of circulants, parity check matrix 205 takes up less space in memory and results in more efficient calculations for the partial syndromes.

In some embodiments, parity check matrix 205 is a circulant matrix with irregular weights. For example, rather than the weight of the columns being even throughout parity check matrix 205, certain columns of matrix columns 225 have higher weights (e.g., more non-zero values) than other columns. Accordingly, certain bits of codeword 210 must satisfy more parity check equations than other bits. In one example, a first group of columns have weights of four (e.g., four values of one in each column of the first group) and a second group of columns have weights of twenty (e.g., twenty values of one in each column in the second group). Computing system 200 can use these irregular parity check matrices to enable more robust error correcting. The higher weights, however, can result in latency delays for computing systems that compute and update the entire syndrome for the parity check matrix. For example, when changing a single bit in the codeword (e.g., correcting a bit based on parity check equations of the parity check matrix) computing systems that compute the entire syndrome need to make changes to the syndrome proportional to the weight of the columns. Accordingly, rather than computing the entirety of the syndrome (e.g., performing a product operation using parity check matrix 205 and codeword 210), error correction termination component 113 computes a partial syndrome using current matrix row 215. This allows error correction termination component 113 to perform the partial syndrome computation in a fewer clock cycles than conventional systems for parity matrices with higher weight columns.

Error correction termination component 113 reads codeword 210 from memory (e.g., from memory device 130). For example, error correction termination component 113 reads codeword 210 from memory device memory devices 130 in response to memory subsystem 110 receiving a memory command from host system 120. In some embodiments, the codeword 210 read from memory contains errors. For example, due to defects, interference, and/or other factors, the data in codeword 210 read from memory contains errors when compared to the original data written to memory. Error correction termination component 113 checks codeword 210 for errors using parity check matrix 205. For example, error correction termination component 113 retrieves parity check matrix 205 from memory (e.g., local memory 119) and uses parity check matrix 205 to determine whether there are errors in codeword 210. In response to determining that there are errors in codeword 210, error correction termination component 113 enters error correction using partial syndromes.

Error correction termination component 113 decodes codeword 210 by calculating partial syndromes for different rows of parity check matrix 205 and codeword 210. For example, error correction termination component 113 implements an error correction algorithm that corrects errors in codeword 210 using a min-sum decoding algorithm. In some embodiments, error correction termination component 113 implements a min-sum decoding algorithm using check nodes and variable nodes of parity check matrix 205. For example, error correction termination component 113 implements a min-sum decoding algorithm that makes hard decisions (e.g., determines a hard decision circulant value) for a bit of codeword 210 based on the output of variable nodes related to that bit of codeword 210. In some embodiments, error correction termination component 113 computes a hard decision circulant value for codeword 210 using circulant 220 of current matrix row 215. A hard decision circulant value refers to the determined intermediate value for a bit of codeword 210. For example, in response to reading codeword 210 from memory, error correction termination component 113 determines hard decision circulant values for the bits of codeword 210 based on the voltage values read from the cells of the memory device (e.g., memory device 130). Error correction termination component 113 uses these hard decision circulant values while decoding codeword 210 for each matrix row 230 of parity check matrix 205. During decoding, error correction termination component 113 updates the hard decision circulant value based on whether the bits of codeword 210 satisfy the parity check equations for the current row (e.g., current matrix row 215) of parity check matrix 205. For example, as described in further detail below, error correction termination component 113 can flip bits (e.g., update the hard decision circulant value for a bit of codeword 210) in response to the partial syndrome for that circulant not being equal to zero.

Error correction termination component 113 computes and/or updates the partial syndrome for current matrix row 215 using the hard decision circulant value and circulant offset values for circulant 220. In some embodiments, the circulant offset values for different circulants are stored in memory. For example, error correction termination component 113 retrieves circulant offset values from local memory 119. While computing and/or updating the partial syndrome, error correction termination component 113 flips any bits in codeword 210 that do not align with the parity check equations for parity check matrix 205.

In some embodiments, error correction termination component 113 determines the next circulant for current matrix row 215. For example, error correction termination component 113 determines the next non-zero circulant and computes and/or updates the partial syndrome using the circulant. For example, error correction termination component 113 computes a partial syndrome for the circulant by performing a product operation using the hard decision circulant values for codeword 210 and the values for the circulant. This improves the overall efficiency of the error correction as some circulants can include only zero values, which would necessarily result in a syndrome calculation of zero and therefore do not need to be computed. Error correction termination component 113 updates the partial syndrome computed using circulant 220 and codeword 210 with each subsequent circulant of current matrix row 215 until the partial syndrome has been calculated for all of current matrix row 215.

Error correction termination component 113 uses an error correction termination counter to determine when to terminate error correction for codeword 210. For example, error correction termination component 113 initializes an error correction termination counter to zero when beginning error correction using parity check matrix 205 and codeword 210. In some embodiments, error correction termination component 113 increments the error correction termination counter for each of matrix rows 230 with partial syndromes that equal zero. For example, error correction termination component 113 calculates the partial syndrome for current matrix row 215 and determines whether the partial syndrome equals zero (e.g., partial syndrome indicates no errors present in codeword 210 based on the parity check equations for current matrix row 215). Although described as incrementing the error correction termination counter, it will be appreciated that the same effect can be achieved by initializing the counter to the number of rows for parity check matrix 205 and decrementing the counter for each partial syndrome that equals zero. Additionally, although described as determining whether the partial syndrome equals zero, the value of the partial syndrome can be compared to other values such that the value being compared corresponds with no errors being present in codeword 210 according to the relevant parity check equations. If the partial syndrome equals zero, error correction termination component 113 increments the error correction termination counter and if the partial syndrome does not equal zero, error correction termination component 113 resets the error correction termination counter.

In some embodiments, error correction termination component 113 increments the error correction termination counter if error correction termination component 113 determines that no errors were corrected for the current row. For example, error correction termination component 113 determines whether any errors were corrected while calculating the partial syndrome. Error correction termination component 113 compares previous hard decision circulant values with current hard decision circulant values. The previous hard decision circulant value can be, for example, the values of codeword 210 for the previous circulant while the current hard decision circulant values are the updated values of codeword 210 for the current circulant. Error correction termination component 113 compares the previous hard decision circulant values with the current hard decision circulant value for each circulant of current matrix row 215 to determine whether an error was corrected for current matrix row 215. For example, if any of the values of codeword 210 are flipped during computation of the partial syndrome for current matrix row 215, error correction termination component 113 determines that an error was corrected. In some embodiments, error correction termination component 113 sets a variable indicating that a bit was flipped. In such embodiments, error correction termination component 113 increments the error correction termination counter in response to determining that no errors were corrected. In some embodiments, error correction termination component 113 resets the error correction termination counter to zero in response to determining that errors were corrected. For example, error correction termination component 113 resets the error correction termination counter because correcting errors means that bits of codeword 210 are changed which could affect the partial syndromes for other rows of parity check matrix 205.

Error correction termination component 113 determines whether the error correction termination counter satisfies an error correction termination threshold. For example, the error correction termination threshold is the number of rows for parity check matrix 205. In some embodiments, error correction termination component 113 retrieves the error correction termination threshold from memory (e.g., local memory 119). In some embodiments, error correction termination component 113 determines whether the error correction termination counter satisfies an error correction termination threshold for each of matrix rows 230. If error correction termination component 113 determines that the error correction termination counter satisfies the error correction termination threshold, error correction termination component 113 exits the error correction and uses the current values for codeword 210 as the corrected user data. For example, if the error correction termination counter is equal to the number of matrix rows 230 of parity check matrix 205, then no bits were flipped in the last pass for each of matrix rows 230 and the partial syndromes for all of matrix rows 230 equal zero. In some embodiments, error correction termination component 113 exits error correction in response to a timeout (e.g., a certain amount of time elapsed and/or certain number of iterations).

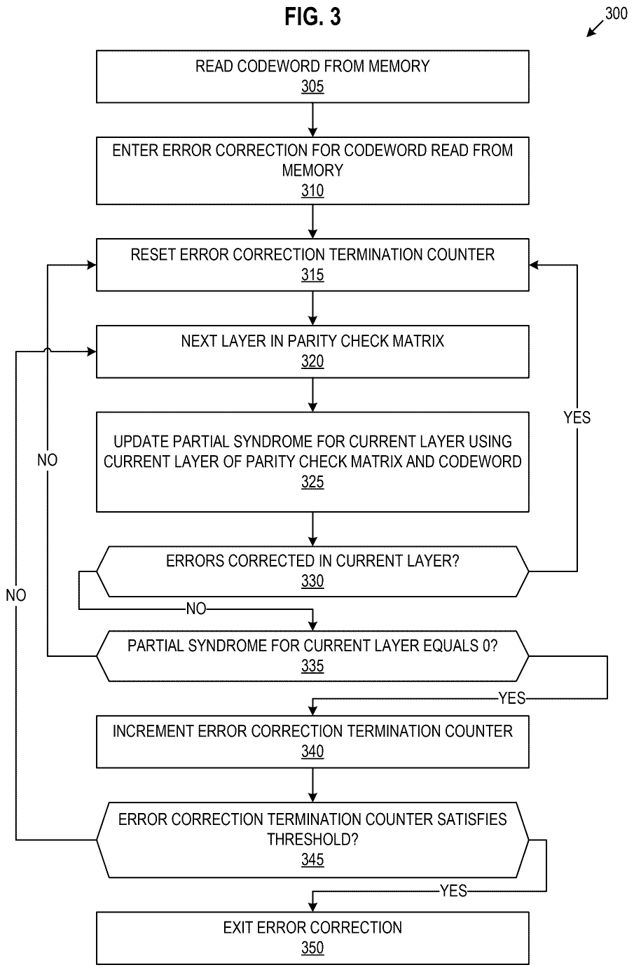

FIG. 3 is a flow diagram of an example method 300 to terminate error correction using partial syndromes, in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the error correction termination component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 305, the processing device reads codeword from memory. For example, error correction termination component 113 reads codeword 210 from a memory device (such as memory device 130 of FIG. 1). Codeword 210 is encoded using parity check matrix 205. In some embodiments, the processing device reads codeword 210 from memory in response to a memory command. For example, the memory subsystem (e.g., memory subsystem 110 of FIG. 1) receives a read command from a host system (e.g., host system 120 of FIG. 1) to read codeword 210. In some embodiments, the processing device reads codeword 210 from memory in response to an internal memory command. For example, error correction termination component 113 reads codeword 210 from memory devices 130 in response to a command generated from within memory subsystem 110. In some embodiments, error correction termination component 113 retrieves parity check matrix 205 in response to receiving and/or otherwise processing a memory command to read codeword 210.

At operation 310, the processing device enters error correction for the codeword read from memory. For example, error correction termination component 113 determines enters error correction in response to determining that user data read from memory (e.g., codeword 210 read from memory device 130) contains a threshold number of errors. In some embodiments, error correction termination component 113 enters error correction in response to determining that codeword 210 includes at least one error. For example, in response to determining that codeword 210 does not satisfy the parity check equations of parity check matrix 205, error correction termination component 113 enters error correction for codeword 210.

In some embodiments, error correction termination component 113 enters error correction in response to determining that codeword 210 includes a threshold number of errors larger than one. For example, if error correction termination component 113 determines that codeword 210 includes one error, error correction termination component 113 uses another method for error correction. If error correction termination component 113 determines that codeword 210 includes at least the threshold number of errors (e.g., two or more), error correction termination component 113 enters error correction using partial syndromes.

At operation 315, the processing device resets the error correction termination counter. For example, error correction termination component 113 uses an error correction termination counter to count the number of subsequent rows in parity check matrix 205 with syndromes equal to zero. In response to entering error correction for codeword 210, error correction termination component 113 sets the error correction termination counter to zero.

In some embodiments, as described in further detail below, error correction termination component 113 resets the error correction termination counter in response to determining that the partial syndrome for the current layer is not zero and/or in response to determining that errors were corrected in the current layer.

At operation 320, the processing device moves to the next layer in the parity check matrix. For example, error correction termination component 113 determines a next matrix row 230 of parity check matrix 205. In some embodiments, error correction termination component 113 moves to the next layer in response to determining that there are no remaining circulants in the current layer. In some embodiments, error correction termination component 113 moves to the next layer in response to determining that there are no remaining non-zero circulants in the current layer.

At operation 325, the processing device updates the partial syndrome for the current layer using the current layer of the parity check matrix and the codeword. For example, error correction termination component 113 calculates a partial syndrome using current matrix row 215 and codeword 210. In some embodiments, error correction termination component 113 calculates the partial syndrome as a product between the current matrix row 215 of the parity check matrix 205 and codeword 210.

In some embodiments, in response to determining that the parity check equation for the current matrix row 215 is not satisfied (e.g., determining that the partial syndrome is not equal to zero), error correction termination component 113 attempts to correct the error. For example, error correction termination component 113 flips a bit of codeword 210 such that the resulting product of the updated codeword and current matrix row 215 equals zero. In some embodiments, the process of correcting the error is performed by variable node units and check node units of error correction termination component 113 for parity check matrix 205.

In some embodiments, error correction termination component 113 calculates the partial syndrome for the current layer using circulants. For example, error correction termination component 113 calculates a partial syndrome using a first circulant 220 for current matrix row 215 and updates the partial syndrome for subsequent circulants by performing a product operation using the partial syndrome for the previous circulant and the current circulant. In some embodiments, error correction termination component 113 determines a next circulant for the current matrix row 215. For example, error correction termination component 113 determines a next circulant as the next non-zero circulant of current matrix row 215.

At operation 330, the processing device determines whether any errors were corrected in the current layer. For example, In some embodiments, in response to determining to flip a bit and/or in response to flipping a bit of codeword 210, error correction termination component 113 determines that an error was corrected for current matrix row 215. Further details regarding determining whether any errors were corrected in the current layer are discussed with reference to FIG. 2. If the processing device determines that errors were corrected in the current layer, the method 300 returns to operation 315 and resets the error correction termination counter. For example, if bits of codeword 210 were flipped while calculating the current partial syndrome, error correction termination component 113 will need to verify that the updated codeword satisfies the parity check equations for all other matrix rows 230 of parity check matrix 205. If the processing device determines that no errors were corrected in the current layer, the method 300 proceeds to operation 335.

At operation 335, the processing device determines whether the partial syndrome for the current layer equals zero. For example, in response to computing the partial syndrome for current matrix row 215, error correction termination component 113 determines whether the computed partial syndrome is zero. In some embodiments, error correction termination component 113 determines whether the partial syndrome for the current layer equals zero in response to determining that there are no more circulants (or no more non-zero circulants) for the current layer. If the processing device determines that the partial syndrome for the current layer does not equal zero, the method 300 returns to operation 315. For example, if the partial syndrome for the current layer is not zero, there are discrepancies between codeword 210 and the parity check equations of parity check matrix 205. Accordingly, error correction termination component 113 resets the error correction termination counter to indicate that the parity check equations for current matrix row 215 and codeword 210 are not satisfied and that further error correcting is required. If the processing device determines that the partial syndrome for the current layer is equal to zero, the method 300 proceeds to operation 340.

At operation 340, the processing device increments the error correction termination counter. For example, in response to determining that there were no errors corrected in current matrix row 215 and in response to determining that the partial syndrome for current matrix row 215 is zero, error correction termination component 113 increments the error correction termination counter to indicate that the partial syndrome for the current layer indicates there are no remaining errors in the data.

At operation 345, the processing device determines whether the error correction termination counter satisfies the threshold. For example, error correction termination component 113 compares the error correction termination counter to a termination threshold for parity check matrix 205. For example, error correction termination component 113 retrieves a termination threshold from local memory (e.g., local memory 119 of FIG. 1) for parity check matrix 205. In some embodiments, the termination threshold is equal to the number of layers (e.g., the number of matrix rows 230) for parity check matrix 205. For example, by setting the termination threshold to the number of layers for parity check matrix 205, error correction termination component 113 ensures that the partial syndrome for every matrix rows 230 is equal to zero and therefore that codeword 210 satisfies the parity check equations for all matrix rows 230.

If the processing device determines that the error correction termination counter does not satisfy the threshold, the processing device returns to operation 320 and moves on to the next layer in the parity check matrix. For example, error correction termination component 113 checks more rows of parity check matrix 205 until the error correction termination counter does satisfy the threshold. If the processing device determines that the error correction termination counter satisfies the threshold, the method 300 proceeds to operation 350.

At operation 350, the processing device exits error correction. For example, error correction termination component 113 decodes codeword 210 according to the bits flipped during error correction. In some embodiments, error correction termination component 113 sends the decoded user data to a host system in response to a read command. For example, in response to receiving a read command from host system 120 (e.g., a read command that initiates operation 305), error correction termination component 113 sends the decoded user data to host system 120. In some embodiments, the processing device exits error correction in response to a timeout (e.g., a certain amount of time elapsed and/or certain number of iterations.

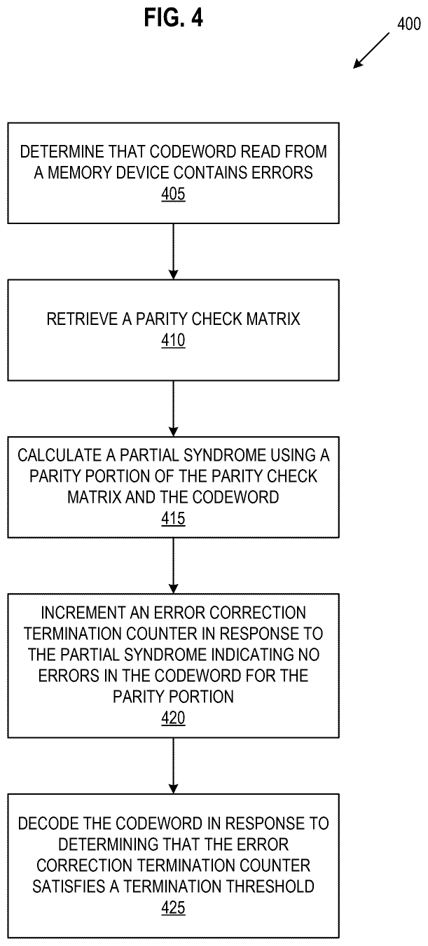

FIG. 4 is a flow diagram of an example method 400 to terminate error correction using partial syndromes, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the error correction termination component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 405, the processing device determines that the codeword read from a memory device contains errors. For example, error correction termination component 113 reads codeword 210 from a memory device (e.g., memory device 130 of FIG. 1) and determines that codeword 210 contains errors in response to codeword 210 failing the parity check for parity check matrix 205. Further details regarding determining that the codeword read from a memory device contains errors are described with reference to FIGS. 2 and 3.

At operation 410, the processing device retrieves a parity check matrix. For example, error correction termination component 113 retrieves parity check matrix 205 from local memory 119 for codeword 210. In some embodiments, the parity check matrix is a circulant matrix. Further details regarding retrieving a parity check matrix are described with reference to FIGS. 2 and 3.

At operation 415, the processing device calculates a partial syndrome using a parity portion of the parity check matrix and the codeword. For example, error correction termination component 113 calculates a partial syndrome using current matrix row 215 of parity check matrix 205 and codeword 210. In some embodiments, error correction termination component 113 calculates the partial syndrome using circulants. For example, error correction termination component 113 calculates a partial syndrome for current matrix row 215 using a first circulant 220 and updates the partial syndrome for

At operation 420, the processing device increments an error correction termination counter in response to the partial syndrome indicating no errors in the codeword for the parity portion. For example, error correction termination component 113 increments an error correction termination counter in response to determining that the partial syndrome for current matrix row 215 is zero. In some embodiments, error correction termination component 113 increments the error correction termination counter in response to determining that no errors were correcting while computing the partial syndrome for current matrix row 215. Further details regarding incrementing the error correction termination counter are discussed with reference to FIGS. 2 and 3.

At operation 425, the processing device decodes the codeword in response to determining that the error correction termination counter satisfies a termination threshold. For example, error correction termination component 113 uses codeword 210 with bits flipped based on the syndrome calculations for matrix rows 230 of parity check matrix 205. Further details regarding decoding the codeword are discussed with reference to FIGS. 2 and 3.

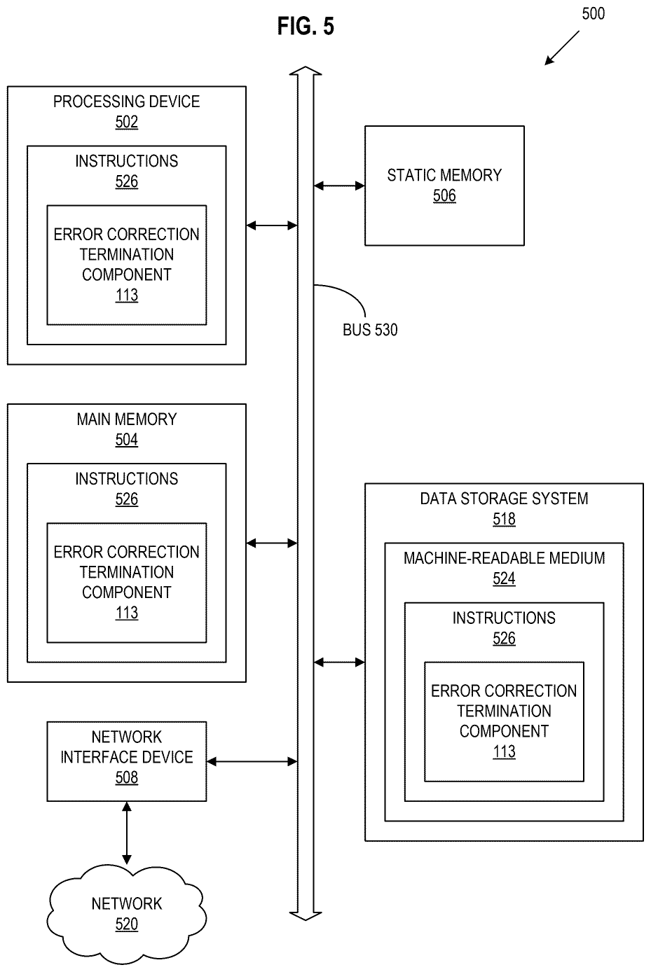

FIG. 5 illustrates an example machine of a computer system 500 within which a set of instructions for causing the machine to perform any one or more of the methodologies discussed herein can be executed. In some embodiments, the computer system 500 can correspond to a host system (e.g., the host system 120 of FIG. 1) that includes, is coupled to, or utilizes a memory subsystem (e.g., the memory subsystem 110 of FIG. 1) or can be used to perform the operations of a controller (e.g., to execute an operating system to perform operations corresponding to the error correction termination component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a smart device, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random-access memory (DRAM) such as synchronous DRAM (SDRAM) or Rambus DRAM (RDRAM), etc.), a static memory 506 (e.g., flash memory, static random-access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526, constituting machine-readable storage media, can also reside, completely or at least partially, within the main memory 504 and/or within the processing device 502 during execution thereof by the computer system 500, the main memory 504 and the processing device 502. The machine-readable storage medium 524, data storage system 518, and/or main memory 504 can correspond to the memory subsystem 10 of FIG. 1.

In one embodiment, the instructions 526 include instructions to implement functionality corresponding to an error correction termination component (e.g., error correction termination component 113 of FIG. 1). While the machine-readable storage medium 524 is shown in an example embodiment to be a single medium, the term “machine-readable storage medium” should be taken to include a single medium or multiple media that store the one or more sets of instructions (e.g., instructions 526). The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the controller 115, may carry out the computer-implemented methods 300 and 400 in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random-access memories (RAMs), EPROMs, EEPROMs, magnetic or optical cards, or any type of media suitable for storing electronic instructions coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
determining that a codeword read from a memory device contains one or more errors;
retrieving a parity check matrix, wherein the parity check matrix comprises a plurality of parity portions;
calculating a partial syndrome using a parity portion of the plurality of parity portions and the codeword;
incrementing an error correction termination counter in response to the partial syndrome indicating no errors in the codeword for the parity portion; and
decoding the codeword in response to determining that the error correction termination counter satisfies a termination threshold.

2. The method of claim 1, wherein incrementing the error correction termination counter is further in response to determining that no errors are corrected while calculating the partial syndrome.

3. The method of claim 1, further comprising:
calculating a second partial syndrome using a second parity portion of the plurality of parity portions and the codeword; and
resetting the error correction termination counter in response to determining that the second partial syndrome indicates errors in the codeword for the second parity portion.

4. The method of claim 1, further comprising:
calculating a second partial syndrome using a second parity portion of the plurality of parity portions and the codeword; and
resetting the error correction termination counter in response to determining that an error of the one or more errors is corrected while calculating the second partial syndrome.

5. The method of claim 1, wherein retrieving the parity check matrix comprises retrieving an irregular parity check matrix.

6. The method of claim 1, wherein the termination threshold is a number of the plurality of parity portions in the parity check matrix.

7. The method of claim 1, wherein each of the plurality of parity portions of the parity check matrix comprises a plurality of parity circulants and wherein calculating the partial syndrome comprises:
determining a parity circulant of the plurality of parity circulants in response to determining that the parity circulant is a non-zero parity circulant;
calculating the partial syndrome using the parity circulant and the codeword;
determining a second parity circulant of the plurality of parity circulants in response to determining that the second parity circulant is a second non-zero parity circulant; and
updating the partial syndrome using the second parity circulant and the codeword.

8. A non-transitory computer-readable storage medium comprising instructions that, when executed by a processing device, cause the processing device to:
determine that codeword read from a memory device contains one or more errors;
retrieve a parity check matrix, wherein the parity check matrix comprises a plurality of parity portions;
calculate a partial syndrome using a parity portion of the plurality of parity portions and the codeword;
increment an error correction termination counter in response to the partial syndrome indicating no errors in the codeword for the parity portion; and
decode the codeword in response to determining that the error correction termination counter satisfies a termination threshold.

9. The non-transitory computer-readable storage medium of claim 8, wherein incrementing the error correction termination counter is further in response to determining that no errors are corrected while calculating the partial syndrome.

10. The non-transitory computer-readable storage medium of claim 8, wherein the processing device is further to:
calculate a second partial syndrome using a second parity portion of the plurality of parity portions and the codeword; and
reset the error correction termination counter in response to determining that the second partial syndrome indicates errors in the codeword for the second parity portion.

11. The non-transitory computer-readable storage medium of claim 8, wherein the processing device is further to:
calculate a second partial syndrome using a second parity portion of the plurality of parity portions and the codeword; and
reset the error correction termination counter in response to determining that an error of the one or more errors is corrected while calculating the second partial syndrome.

12. The non-transitory computer-readable storage medium of claim 8, wherein retrieving the parity check matrix comprises retrieving an irregular parity check matrix.

13. The non-transitory computer-readable storage medium of claim 8, wherein the termination threshold is a number of the plurality of parity portions in the parity check matrix.

14. The non-transitory computer-readable storage medium of claim 8, wherein each of the plurality of parity portions of the parity check matrix comprises a plurality of parity circulants and wherein calculating the partial syndrome comprises:
determining a parity circulant of the plurality of parity circulants in response to determining that the parity circulant is a non-zero parity circulant;
calculating the partial syndrome using the parity circulant and the codeword;
determining a second parity circulant of the plurality of parity circulants in response to determining that the second parity circulant is a second non-zero parity circulant; and
updating the partial syndrome using the second parity circulant and the codeword.

15. A system comprising:
a plurality of memory devices; and
a processing device, operatively coupled with the plurality of memory devices, to:
determine that codeword read from a memory device contains one or more errors;
retrieve a parity check matrix, wherein the parity check matrix comprises a plurality of parity portions;
calculate a partial syndrome using a parity portion of the plurality of parity portions and the codeword;
increment an error correction termination counter in response to the partial syndrome indicating no errors in the codeword for the parity portion and in response to determining that no errors are corrected while calculating the partial syndrome; and
decode the codeword in response to determining that the error correction termination counter satisfies a termination threshold.

16. The system of claim 15, wherein the processing device is further to:
calculate a second partial syndrome using a second parity portion of the plurality of parity portions and the codeword; and
reset the error correction termination counter in response to determining that the second partial syndrome indicates errors in the codeword for the second parity portion.

17. The system of claim 15, wherein the processing device is further to:
calculate a second partial syndrome using a second parity portion of the plurality of parity portions and the codeword; and
reset the error correction termination counter in response to determining that an error of the one or more errors is corrected while calculating the second partial syndrome.

18. The system of claim 15, wherein retrieving the parity check matrix comprises retrieving an irregular parity check matrix.

19. The system of claim 15, wherein the termination threshold is a number of the plurality of parity portions in the parity check matrix.

20. The system of claim 15, wherein each of the plurality of parity portions of the parity check matrix comprises a plurality of parity circulants and wherein calculating the partial syndrome comprises:
determining a parity circulant of the plurality of parity circulants in response to determining that the parity circulant is a non-zero parity circulant;
calculating the partial syndrome using the parity circulant and the codeword;
determining a second parity circulant of the plurality of parity circulants in response to determining that the second parity circulant is a second non-zero parity circulant; and
updating the partial syndrome using the second parity circulant and the codeword.
